(19) United States
(12) Patent Application Publication
(10) Pub. No.: US 2014/0098467 A1
(43) Pub. Date: Apr. 10, 2014

(54) ELECTROCONDUCTIVE POLYMER, ELECTROCONDUCTIVE POLYMER AQUEOUS SOLUTION, ELECTROCONDUCTIVE POLYMER FILM, SOLID ELECTROLYTIC CAPACITOR AND METHOD FOR PRODUCING THE SAME

(71) Applicants: Yasuhisa Sugawara, Miyagi (JP); Tomoki Nobuta, Miyagi (JP); Yuji Yoshida, Miyagi (JP); Satoshi Suzuki, Miyagi (JP); Yasuhiro Tomioka, Miyagi (JP)

(72) Inventors: Yasuhisa Sugawara, Miyagi (JP); Tomoki Nobuta, Miyagi (JP); Yuji Yoshida, Miyagi (JP); Satoshi Suzuki, Miyagi (JP); Yasuhiro Tomioka, Miyagi (JP)

(73) Assignee: NEC TOKIN Corporation

(21) Appl. No.: 14/119,848

(22) PCT Filed: May 30, 2012
(86) PCT No.: PCT/JP2012/063836

§ 371 Date: Nov. 22, 2013

(30) Foreign Application Priority Data
May 30, 2011 (JP) 2011-120479

(51) Int. Cl. H01G 9/025; H01G 9/00

(52) U.S. Cl. CPC H01G 9/025; H01G 9/0029
USPC 361/525; 252/62.2; 526/256; 29/25.03

(57) ABSTRACT

An electroconductive polymer having high electroconductivity, an electroconductive polymer aqueous solution, and an electroconductive polymer film are provided. Further, a solid electrolytic capacitor having a reduced ESR and a method for producing the same are provided. An electroconductive polymer according to an exemplary embodiment of the invention contains a monomolecular organic acid having one anion group and one or more hydrophilic group.

### TECHNICAL FIELD

An exemplary embodiment of the invention relates to an electroconductive polymer, an electroconductive polymer aqueous solution, an electroconductive polymer film obtained from the electroconductive polymer aqueous solution, a solid electrolytic capacitor using them, and a method for producing the same.

### BACKGROUND ART

Electroconductive polymer materials are used for electrodes of capacitors, electrodes of dye-sensitization solar cells, electrodes of electroluminescence displays, and the like. As the electroconductive polymer material, polymer materials obtained by polymerizing pyrrole, thiophene, 3,4-ethylenedioxythiophene, aniline, or the like are known. Patent documents 1 and 2 disclose a technology relevant to this.

Patent document 1 relates to a polythiophene solution (dispersion), a method for producing the same, and use of a salt for antistatic treatment of a plastic molding. Specifically, it discloses a polythiophene dispersion having a structural unit of 3,4-dialkoxy thiophene in the presence of a polyanion (which means a polystyrene sulfonic acid in the document). It discloses that this polythiophene dispersion is produced by an oxidation polymerization of 3,4-dialkoxy thiophene at a temperature of 0 to 100° C. in the presence of a polyacid.

Patent document 2 relates to an aqueous dispersion of a complex of a poly(3,4-dialkoxy thiophene) and a polyanion and a method for producing the same as well as to a coating composition containing the aqueous dispersion and a coated substrate having a transparent electroconductive film on which the composition is applied. Specifically, it discloses an aqueous dispersion of a complex of a poly(3,4-dialkoxy thiophene) and a polyanion which is produced by a polymerization of a 3,4-dialkoxy thiophene in an aqueous solvent in the presence of a polyanion using peroxodisulfuric acid as the oxidant.

### PRIOR ART DOCUMENT

### Patent Document

Patent document 1: JP 7-90060 A

Patent document 2: JP 2004-59666 A

### SUMMARY OF THE INVENTION

### Problem to be Solved by the Invention

Polyanions such as polystyrene sulfonic acids are originally an insulating material, but have hydrophilic property which contributes to water-solubility other than a role as a dopant for providing an electroconductivity. In the method of a chemical oxidation polymerization of 3,4-dialkoxy thiophene, 3,4-ethylenedioxy thiophene, or the like in the presence of such a polyanion, it is difficult to control a content (doping ratio). When the effect of the hydrophilic property is attempted to be improved, it is not doped into an electroconductive polymer, which means a state that an excess polyanion which does not contribute to providing an electroconductivity exists. Thus, in the methods disclosed in Patent documents 1 and 2, there is a problem that this polyanion prevents the contact between particles of the electroconductive polymer, which causes the electroconductivity to be decreased.

Also, it seems to be possible to obtain a sufficient electroconductivity to the antistatic material as disclosed in Patent document 2 by the electroconductive polymer as mentioned above. However, for example, in the case of using it for an electrode of a solid electrolytic capacitor (capacitor element) or the like, there is a problem that further reducing of equivalent series resistance (ESR) is difficult from the standpoint of the electroconductivity.

Thus, the object of an exemplary embodiment of the invention is to provide an electroconductive polymer having high electroconductivity, an electroconductive polymer aqueous solution obtained by using the electroconductive polymer having high electroconductivity, and an electroconductive polymer film. Further, it is to provide a solid electrolytic capacitor having a reduced ESR and a method for producing the same.

### Means of Solving the Problem

In order to solve the above-mentioned problem, an electroconductive polymer according to an exemplary embodiment of the invention contains a monomolecular organic acid having one anion group and one or more hydrophilic group.

In an electroconductive polymer according to an exemplary embodiment of the invention, the anion group is preferably sulfo group (—SO₃H).

In an electroconductive polymer according to an exemplary embodiment of the invention, the hydrophilic group is preferably at least one selected from the group consisting of sulfo group (—SO₃H), carboxyl group (—COOH), amino group (—NH₂), and hydroxyl group (—OH).

In an electroconductive polymer according to an exemplary embodiment of the invention, the monomolecular organic acid is preferably aniline-2,4-disulfonic acid.

Here, the behaviors of a monomolecular organic acid and a polymer (polymer) according to an exemplary embodiment of the invention are described.

The monomolecular organic acid used in an exemplary embodiment of the invention has a restriction due to steric structure to a polymer composed of, for example, a polypyrrole, a polythiophene, or a derivative thereof, and the number of the functional group doped for providing an electroconductivity is one. A case of using aniline-2,4-disulfonic acid previously described as the monomolecular organic acid is described as an example.

Aniline-2,4-disulfonic acid has three functional groups including one amino group and two sulfo group as shown in formula (1) described below. In this case, among the functional groups, the sulfo group has a strongest withdrawing function of a conjugated π electron which influences realization of an electroconductivity. Sulfo group becomes an anion group when it is doped, while it has a property of acting as a hydrophilic group when it is not doped. Thus, one sulfo group withdraws a conjugated π electron and is doped into the above-mentioned polymer, which leads to contribution of providing an electroconductivity, while another sulfo group which is not doped contributes to providing water-solubility. Also, amino group contributes to providing water-solubility as a hydrophilic group. In this way, an electroconductive polymer having a high electroconductivity according to an exemplary embodiment of the invention is obtained.

An electroconductive polymer aqueous solution according to an exemplary embodiment of the invention is obtained by dissolving or dispersing the above-mentioned electroconductive polymer.

An electroconductive polymer film according to an exemplary embodiment of the invention is obtained by dry the above-mentioned electroconductive polymer aqueous solution to remove a solvent.

A solid electrolytic capacitor according to an exemplary embodiment of the invention includes an anode conductor containing a valve metal and a dielectric layer formed on a surface of the anode conductor, wherein a solid electrolyte layer including the above-mentioned electroconductive polymer film is formed on a surface of the dielectric layer.

A method for producing a solid electrolytic capacitor according to an exemplary embodiment of the invention includes: forming a dielectric layer on a surface of an anode conductor containing a valve metal and forming a solid electrolyte layer by impregnating a surface of the dielectric layer with the above-mentioned electroconductive polymer aqueous solution.

A method for producing a solid electrolytic capacitor according to an exemplary embodiment of the invention includes: forming an dielectric layer on a surface of an anode conductor containing a valve metal; forming a first electroconductive polymer compound layer on a surface of the dielectric layer by a chemical oxidation polymerization or an electropolymerization of a monomer providing a first electroconductive polymer compound; and forming a second electroconductive polymer compound layer by impregnating a surface of the first electroconductive polymer compound layer with the above-mentioned electroconductive polymer aqueous solution.

### Effect of the Invention

According to an exemplary embodiment of the invention, an electroconductive polymer having high electroconductivity, an electroconductive polymer aqueous solution, and an electroconductive polymer film can be provided. Further, a solid electrolytic capacitor having a reduced ESR and a method for producing the same can be provided.

### BRIEF DESCRIPTION OF DRAWING

FIG. 1 is a schematic sectional view showing a conformation of a solid electrolytic capacitor according to an exemplary embodiment of the invention.

### MODE FOR CARRYING OUT THE INVENTION

As follows, an electroconductive polymer according to an exemplary embodiment of the invention, an electroconductive polymer aqueous solution, and an electroconductive polymer film obtained from the aqueous solution as well as a solid electrolytic capacitor using these and a method for producing the same are explained in detail.

### (Electroconductive Polymer)

An electroconductive polymer according to an exemplary embodiment of the invention is an electroconductive polymer into which a monomolecular organic acid having one anion group as a dopant and one or more hydrophilic group for providing water-solubility to the electroconductive polymer is doped. Thus, an electroconductive polymer according to an exemplary embodiment of the invention does not contain an excess polyanion which does not contribute to the electroconductivity, and thereby the electrical property such as the excellent electroconductivity can be obtained.

Further, a monomolecular organic acid doped into an electroconductive polymer according to an exemplary embodiment of the invention is a monomolecular organic acid having one or more hydrophilic group for providing water-solubility to the electroconductive polymer. Doping this monomolecular organic acid into the electroconductive polymer provide a property of good solubility or dispersibility in a solvent such as water to the electroconductive polymer.

Note that, “electroconductive polymer containing a monomolecular organic acid” means a state in which the electroconductive polymer contains a polymer composed of the electroconductive polymer and a monomolecular organic acid as a dopant which is doped into the polymer. Also, “monomolecular organic acid” means an organic acid composed of one molecule, and examples thereof do not include polymer organic acids having a repeating structure of a unit. The molecular weight of the monomolecular organic acid is preferably 75 or more and 300 or less.

Examples of the anion group in the monomolecular organic acid for doping include sulfo group (—SO₃H) and carboxyl group (—COOH). Since high electroconductivity can be obtained, it is preferably sulfo group (—SO₃H). Note that, the anion group in the monomolecular organic acid is a group which becomes an anion group by doping it into the polymer. Also, the monomolecular organic acid may have two or more anion groups, but it preferably has one anion group.

Also, in order to make the solubility or dispersibility of the electroconductive polymer in the solvent good, the hydrophilic group in the monomolecular organic acid for providing water-solubility is preferably at least one selected from the group consisting of sulfo group (—SO₃H), carboxyl group (—COOH), amino group (—NH₂), and hydroxyl group (—OH). Note that, the hydrophilic group means a group which makes a week bond to water molecule by electrostatic action, hydrogen bond, or the like, and which becomes stable in water. Also, in the case where the hydrophilic group (for example, sulfo group) is doped into the polymer and becomes an anion group, the group is assumed to be an anion group.

The monomolecular organic acid preferably has two or more hydrophilic groups. Also, the monomolecular organic acid preferably has four or less hydrophilic groups.

Examples of the monomolecular organic acid include aminomethanesulfonic acid, 3-aminopropanesulfonic acid, 5-sulfosalicylic acid, o-aminobenzenesulfonic acid, m-aminobenzenesulfonic acid, p-aminobenzenesulfonic acid, o-sulfobenzoic acid, m-sulfobenzoic acid, p-sulfobenzoic acid, 4-amino-2-chlorotoluene-5-sulfonic acid, 4-amino-3-methylbenzene-1-sulfonic acid, 4-amino-5-methoxy-2-methylbenzenesulfonic acid, 2-amino-5-methylbenzene-1-sulfonic acid, 4-amino-2-methylbenzene-1-sulfonic acid, 5-amino-2-methylbenzene-1-sulfonic acid, 4-amino-3-methylbenzene-1-sulfonic acid, 1-amino-2-naphthol-4-sulfonic acid, 2-amino-5-naphthol-7-sulfonic acid, ethanedisulfonic acid, butanedisulfonic acid, pentanedisulfonic acid, decanedisulfonic acid, o-benzenedisulfonic acid, m-benzenedisulfonic acid, p-benzenedisulfonic acid, toluenedisulfonic acid, xylenedisulfonic acid, chlorobenzenedisulfonic acid, fluorobenzenedisulfonic acid, dimethylbenzenedisulfonic acid, diethylbenzenedisulfonic acid, 3,5-disulfobenzoic acid, aniline-2,4-disulfonic acid, aniline-2,5-disulfonic acid, 3,4-dihydroxy-1,3-benzenedisulfonic acid, naphthalenedisulfonic acid, methylnaphthalenedisulfonic acid, ethylnaphthalenedisulfonic acid, pentadecylnaphthalenedisulfonic acid, 3-amino-5-hydroxy-2,7-naphthalenedisulfonic acid, 1-acetamide-8-hydroxy-3,6-naphthalenedisulfonic acid, 1-amino-3,8-naphthalenedisulfonic acid, 3-amino-1,5-naphthalenedisulfonic acid, 4-amino-5-naphthol-2,7-disulfonic acid. This monomolecular organic acid may be used alone or in combination with two or more kinds. Among these, from the standpoint of providing good electroconductivity and water-solubility, aniline-2,4-disulfonic acid represented by following formula (1) is particularly preferable.

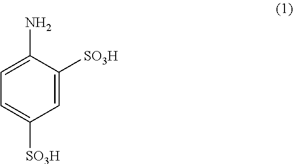 [SMILES: Nc1ccc(S(=O)(=O)O)cc1S(=O)(=O)O]

Examples of the polymer composed of the electroconductive polymer include polypyrroles, polythiophenes, or derivatives thereof. Among these, from the standpoint of the electroconductivity, it is preferably a poly(3,4-ethylenedioxy thiophene)s having a structural unit represented by following formula (2), which is a derivative of polythiophenes, or a derivative thereof. Examples of the derivatives of poly(3,4-ethylenedioxy thiophene) include poly(alkylated 3,4-ethylenedioxy thiophene) obtained by substituting ethylene part of following formula (2) with an alkyl group. The electroconductive polymer may be a homopolymer or may also be a copolymer, and further may be one kind or may also be two or more kinds.

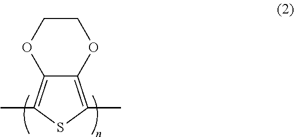

### (Electroconductive Polymer Aqueous Solution)

An electroconductive polymer aqueous solution according to an exemplary embodiment of the invention is an aqueous solution obtained by dissolving or dispersing an electroconductive polymer according to an exemplary embodiment of the invention. Since it does not contain an excess polyanion which does not contribute to the electroconductivity, an electroconductive polymer film having an excellent electroconductivity can be obtained.

The solvent of the electroconductive polymer aqueous solution is preferably a mixed solvent of water and a polar organic solvent such as an alcohol, acetone, acetonitrile, ethyleneglycol. However, water is more preferably from the standpoint of ease of placing an exhausting equipment for evaporating a solvent vapor in the step of drying the electroconductive polymer aqueous solution, low environmental load, and ease of removal.

The content of the electroconductive polymer in the electroconductive polymer aqueous solution is preferably 0.1 part by mass or more and 30.0 parts by mass or less with respect to 100 parts by mass of water that is a solvent from the standpoint of good solubility or dispersibility, and is more preferably 0.5 part by mass or more and 20.0 parts by mass or less.

From the standpoint of improving the adhesion of the electroconductive polymer, the electroconductive polymer aqueous solution preferably contains a resin and/or a substance which is changed to a resin by a reaction by heat or light, as a binder.

Examples of the binder include polyvinyl alcohols, polyvinylpyrrolidones, polyvinyl chlorides, polyvinyl acetates, polyvinyl butyrates, polyacrylates, polyacrylic acid amides, polymethacrylates, polymethacrylic acid amides, polyacrylonitriles, copolymers of styrene/acrylate, vinyl acetate/acrylate, and ethylene/vinyl acetate, polybutadienes, polyisoprenes, polystyrenes, polyethers, polyesters, polycarbonates, polyurethanes, polyamides, polyimides, polyamide-imides, polysulfones, melamine-formaldehyde resins, epoxide resins, silicone resins, and celluloses.

Examples of the resin and/or the substance which is changed to a resin by a reaction by heat or light include, for example, a mixture of a water-soluble polyol such as erythritol or pentaerythritol and a water-soluble organic substance having two or more carboxyl groups such as adipic acid or phthalic acid. The water-soluble polyol and the water-soluble organic substance having two or more carboxyl groups are reacted by heat and are changed to a polyester. The binder may be one kind or may also be two or more kinds.

### (Electroconductive Polymer Film)

An electroconductive polymer film according to an exemplary embodiment of the invention is a film obtained by drying an electroconductive polymer aqueous solution according to an exemplary embodiment of the invention to remove a solvent, and has excellent adhesion to a substrate and a high electroconductivity. The drying temperature to remove the solvent is preferably 300° C. or less in consideration of preventing heat decomposition of the electroconductive polymer.

### (Solid Electrolytic Capacitor and Method for Producing the Same)

A solid electrolytic capacitor according to an exemplary embodiment of the invention has a solid electrolyte layer containing an electroconductive polymer according to an exemplary embodiment of the invention. In a solid electrolytic capacitor according to an exemplary embodiment of the invention, since the material (film) for forming the solid electrolyte layer has a high electroconductivity, the solid electrolytic capacitor comes to have a low ESR.

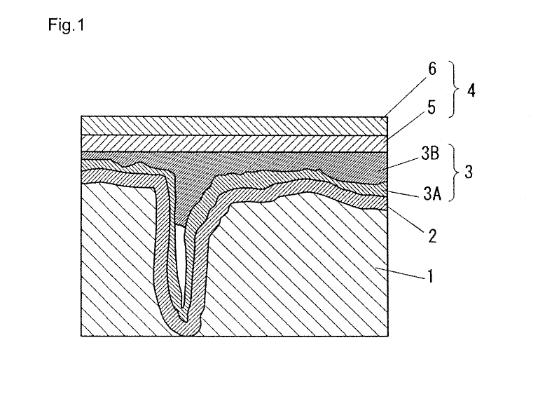

A schematic sectional view showing a conformation of a solid electrolytic capacitor according to an exemplary embodiment of the invention is shown in FIG. 1. This solid electrolytic capacitor has a conformation in which dielectric layer 2, solid electrolyte layer 3, and cathode conductor 4 are formed on the surface of anode conductor 1 in this order.

Note that, the sectional view of FIG. 1 shows a cathode portion which becomes an area for obtaining a capacity of the capacitor element. Thus, an anode portion which is connected to an anode terminal of the capacitor element is omitted. The cathode portion and the anode portion are respectively provided by dividing a valve metal for forming above-mentioned anode conductor 1 by applying an insulating resin (not shown).

Anode conductor 1 is formed of: a material obtained by subjecting a plate, a foil, or a wire of a valve metal to a surface area enlargement treatment by etching; a sintered body obtained by sintering a molded body of a valve metal fine particle, which has the same role as the material obtained by a surface area enlargement treatment; or the like. Examples of the valve metal include tantalum, aluminum, titanium, niobium, zirconium, and alloys thereof. This may be used alone or in combination with two or more kinds. Among these, at least one valve metal selected from the group consisting of aluminum, tantalum, and niobium is preferable from the standpoint of processability.

Dielectric layer 2 is a layer formed by an electrolytic oxidation of the surface of anode conductor 1, and is also formed in the pores of a sintered body or a porous body. The thickness of dielectric layer 2 can be appropriately adjusted by the voltage of the electrolytic oxidation.

Solid electrolyte layer 3 is formed of an electroconductive polymer or an electroconductive polymer film according to an exemplary embodiment of the invention. Solid electrolyte layer 3 may have a single-layered conformation, but may also be a multi-layered conformation. FIG. 1 shows a case of the multi-layered conformation, and solid electrolyte layer 3 includes first electroconductive polymer compound layer 3A and second electroconductive polymer compound layer 3B.

Solid electrolyte layer 3 may further contain an electroconductive polymer obtained by polymerizing pyrrole, thiophene, aniline, or a derivative thereof, other than an electroconductive polymer according to an exemplary embodiment of the invention; an oxide derivative such as manganese dioxide or ruthenium oxide, or an organic semiconductor such as TCNQ (7,7,8,8-tetracyanoquinodimethane complex salt).

Examples of the method for forming solid electrolyte layer 3 include a method by impregnating a surface of dielectric layer 2 with an electroconductive polymer aqueous solution according to an exemplary embodiment of the invention and by removing the solvent from the electroconductive polymer aqueous solution, in the case of the single-layered conformation.

Also, solid electrolyte layer 3 in the solid electrolytic capacitor shown in FIG. 1 is obtained, for example, by the following methods. First, first electroconductive polymer compound layer 3A is formed on the surface of dielectric layer 2 by a chemical oxidation polymerization or an electropolymerization of a monomer providing a first electroconductive polymer compound. Second electroconductive polymer compound layer 3B is formed by impregnating a surface of first electroconductive polymer compound layer 3A with an electroconductive polymer aqueous solution according to an exemplary embodiment of the invention.

As the monomer providing a first electroconductive polymer compound, at least one selected from the group consisting of pyrrole, thiophene, aniline, and derivatives thereof can be used. The dopant used for obtaining a first electroconductive polymer compound by a chemical oxidation polymerization or an electropolymerization of this monomer is preferably a sulfonic acid compound such as benzenesulfonic acid, naphthalenesulfonic acid, phenolsulfonic acid, styrenesulfonic acid, or a derivative thereof.

As for the molecular weight of the dopant, it can appropriately be selected from low molecular weight compounds and high molecular weight compounds.

The solvent may be a mixed solvent containing water and a water-soluble organic solvent as mentioned above, but may also be water.

As the impregnation method, the impregnation is preferably repeated from the standpoint of uniformly forming the electroconductive polymer compound layer. Further, the impregnation is preferably carried out in a reduced-pressure environment from atmospheric pressure or in a pressurized environment from atmospheric pressure from the standpoint of raising the impregnation efficiency. Also, in order to sufficiently fill the electroconductive polymer aqueous solution into the porous pore inside, it is preferably left for several minutes to several ten minutes after the impregnation.

The removal of the solvent from the electroconductive polymer aqueous solution can be carried out by drying the electroconductive polymer aqueous solution. The drying temperature is not particularly limited as long as it is in a temperature range at which the solvent can be removed, but is preferably 300° C. or lower from the standpoint of preventing the deterioration of the element by heat. The drying time can be appropriately optimized by the drying temperature, but is not particularly limited as long as the electroconductivity is not damaged.

Cathode conductor 4 is not particularly limited as long as it is a conductor, but may have a two-layered conformation including graphite layer 5 and silver electroconductive resin layer 6.

### EXAMPLES

### Example 1

3,4-ethylenedioxy thiophene (1 g) that was a monomer was dispersed in water (30 mL) with stirring. Further, aniline-2,4-disulfonic acid (5 g) that was a dopant and iron (III) sulfate (1 g) that was an oxidant were dissolved. The solution obtained was stirred at room temperature for 48 hours to carry out an oxidation polymerization of the monomer.

An electrodialysis and a liquid separation of the solution obtained in the above-mentioned step were respectively carried out multiple times to remove the impurity. Thereby, an electroconductive polymer aqueous solution containing a poly(3,4-ethylenedioxy thiophene), in which aniline-2,4-disulfonic acid with no impurity was doped, was obtained.

100 μl of the electroconductive polymer aqueous solution obtained was dropped on a surface of a glass substrate, and the solvent was volatilized and dried with a thermostatic oven at 125° C. Thereby, an electroconductive polymer film according to an exemplary embodiment of the invention was formed.

The surface resistance (Ω/□) and the film thickness of the electroconductive polymer film obtained were measured by four-terminal method (JIS K 7194), and the electroconductivity (S/cm) was calculated.

The result is shown in TABLE 1.

### Example 2

An electroconductive polymer aqueous solution was produced in the same manner as in Example 1 except that 5-sulfosalicylic acid was used as the dopant. An electroconductive polymer film was formed and the electroconductivity thereof was evaluated in the same manner as in Example 1 except that the electroconductive polymer aqueous solution obtained was used. The result is shown in TABLE 1.

### Example 3

A self-emulsified polyester dispersion (0.3 g) was added as a binder to the electroconductive polymer aqueous solution (20 g) obtained in Example 1. The self-emulsified polyester dispersion was dissolved by stirring this solution at room temperature for 24 hours to produce an electroconductive polymer aqueous solution. An electroconductive polymer film was formed and the electroconductivity thereof was evaluated in the same manner as in Example 1 except that the electroconductive polymer aqueous solution obtained was used. The result is shown in TABLE 1.

### Comparative Example 1

By the method described in Example 1 of Patent document 1, an electroconductive polymer aqueous solution was produced. Specifically, 3,4-ethylenedioxy thiophene (0.5 g), a polystyrene sulfonic acid (2 g) with a weight average molecular weight of 4,000, and iron (III) sulfate (0.05 g) were added to water (20 mL), and it was stirred at room temperature for 24 hours. Thereby, an electroconductive polymer aqueous solution was produced. An electroconductive polymer film was formed and the electroconductivity thereof was evaluated in the same manner as in Example 1 except that the electroconductive polymer aqueous solution obtained was used. The result is shown in TABLE 1.

TABLE 1

| | electroconductivity (S/cm) |
|---|---|
| Ex. 1 | 208 |
| Ex. 2 | 182 |
| Ex. 3 | 194 |
| Comp. Ex. 1 | 90 |

As shown in TABLE 1, the electroconductive polymer films obtained in Examples 1 to 3 had a higher electroconductivity than that of the electroconductive polymer film obtained in Comparative Example 1. Thereby, the effect of realizing a high electroconductivity by an exemplary embodiment of the invention has been confirmed.

It is inferred that the effect of realizing a high electroconductivity can be obtained because the electroconductive polymer film does not contains an excess polyanion which does not contribute to the electroconductivity, or the like.

### Example 4

A porous aluminum was used as an anode conductor containing a valve metal. An oxide film that was a dielectric layer was formed on the surface of the aluminum by anodic oxidation. By applying an insulating resin to the anode conductor, it was divided into an anode portion which was connected to an anode terminal and a cathode portion for obtaining a capacity. Then, the area of the anode conductor that came to be the cathode portion, in which the dielectric layer was formed, was immersed in the electroconductive polymer aqueous solution produced in Example 1, and it was pulled up. After that, it was dried and solidified with a thermostatic oven at 125° C. to form a solid electrolyte layer. On the solid electrolyte layer, a cathode conductor including a graphite layer and a silver electroconductive resin was formed. Thereby, a solid electrolytic capacitor was produced.

The ESR of this solid electrolytic capacitor was measured at a frequency of 100 kHz using an LCR meter. The ESR value was converted from the total area of the cathode portion to a unit area (1 cm²). The measurement result is shown in TABLE 2.

### Example 5

A solid electrolytic capacitor was produced in the same manner as in Example 4 except that the electroconductive polymer aqueous solution obtained in Example 2 was used. The result of the ESR of the solid electrolytic capacitor measured by the same method as that in Example 4 is shown in TABLE 2.

### Example 6

A solid electrolytic capacitor was produced in the same manner as in Example 4 except that the electroconductive polymer aqueous solution obtained in Example 3 was used. The result of the ESR of the solid electrolytic capacitor measured by the same method as that in Example 4 is shown in TABLE 2.

### Example 7

A porous aluminum was used as an anode conductor containing a valve metal. An oxide film that was a dielectric layer was formed on the surface of the aluminum by anodic oxidation. In the same manner as in Example 4, it was divided into an anode portion and a cathode portion by an insulating resin. Then, the area of the anode conductor that came to be the cathode portion, in which the dielectric layer was formed, was immersed in a monomer liquid obtained by dissolving pyrrole (10 g) in pure water (200 mL), and it was pulled up. Further, it was immersed in an oxidant liquid obtained by dissolving p-toluenesulfonic acid (20 g) as a dopant and ammonium persulfate (10 g) as an oxidant in pure water (200 mL), and it was pulled up. These immersing and pulling up steps were repeated 10 times and a chemical oxidation polymerization was carried out. Thereby, a first electroconductive polymer compound layer was formed.

The electroconductive polymer aqueous solution produced in Example 1 was dropped on the surface of the first electroconductive polymer compound layer and was immersed. After that, it was dried and solidified with a thermostatic oven at 125° C. Thereby, a second electroconductive polymer compound layer was formed.

A graphite layer and a silver electroconductive resin were formed in this order on the surface of the solid electrolyte layer including the first electroconductive polymer compound layer and the second electroconductive polymer compound layer. Thereby, a solid electrolytic capacitor was produced. The result of the ESR of the solid electrolytic capacitor measured by the same method as that in Example 4 is shown in TABLE 2.

### Example 8

A solid electrolytic capacitor was produced in the same manner as in Example 7 except that the electroconductive polymer aqueous solution obtained in Example 2 was used. The result of the ESR of the solid electrolytic capacitor measured by the same method as that in Example 4 is shown in TABLE 2.

### Example 9

A solid electrolytic capacitor was produced in the same manner as in Example 7 except that the electroconductive polymer aqueous solution obtained in Example 3 was used. The result of the ESR of the solid electrolytic capacitor measured by the same method as that in Example 4 is shown in TABLE 2.

### Example 10

A solid electrolytic capacitor was produced in the same manner as in Example 4 except that a porous tantalum was used as the anode conductor containing a valve metal. The result of the ESR of the solid electrolytic capacitor measured by the same method as that in Example 4 is shown in TABLE 2.

### Comparative Example 2

A solid electrolytic capacitor was produced in the same manner as in Example 4 except that the electroconductive polymer aqueous solution obtained in Comparative Example 1 was used. The result of the ESR of the solid electrolytic capacitor measured by the same method as that in Example 4 is shown in TABLE 2.

TABLE 2

| | ESR (mΩ · cm²) |
|---|---|
| Ex. 4 | 1.4 |
| Ex. 5 | 1.6 |
| Ex. 6 | 1.3 |
| Ex. 7 | 1.5 |
| Ex. 8 | 1.5 |
| Ex. 9 | 1.3 |
| Ex. 10 | 2.0 |
| Comp. Ex. 2 | 3.2 |

As shown in TABLE 2, the solid electrolytic capacitors obtained in Examples 4 to 10 had a reduced ESR in comparison with the solid electrolytic capacitor obtained in Comparative Example 2. This is inferred to be because the electroconductive polymer films used in Examples 4 to 10 have a high electroconductivity. By using an electroconductive polymer film according to an exemplary embodiment of the invention for solid electrolyte layer, the resistance of the solid electrolyte layer is decreased, which leads to reducing the ESR of the solid electrolytic capacitor.

This application claims the priority based on Japanese Patent Application No. 2011-120479 filed on May 30, 2011, all the disclosure of which is incorporated herein by reference.

The embodiment of this invention was explained using the Examples in the above, but this invention is not limited to the Examples and the present invention includes an embodiment after a design variation within a scope of this invention. That is, the present invention includes an embodiment after various changings or modifications which can be made naturally by a person ordinarily skilled in the art.

### REFERENCE SIGNS LIST

1 anode conductor
2 dielectric layer
3 solid electrolyte layer
3A first electroconductive polymer compound layer
3B second electroconductive polymer compound layer
4 cathode conductor
5 graphite layer
6 silver electroconductive resin layer

1-14. (canceled)

15. An electroconductive polymer, comprising a monomolecular organic acid having one anion group and one or more hydrophilic group.

16. The electroconductive polymer according to claim 15, wherein the anion group is sulfo group (—SO₃H).

17. The electroconductive polymer according to claim 15, wherein the hydrophilic group is at least one selected from the group consisting of sulfo group (—SO₃H), carboxyl group (—COOH), amino group (—NH₂), and hydroxyl group (—OH).

18. The electroconductive polymer according to claim 15, wherein the monomolecular organic acid is aniline-2,4-disulfonic acid.

19. The electroconductive polymer according to claim 15, being a polymer composed of pyrrole, thiophene, or a derivative thereof.

20. An electroconductive polymer aqueous solution, obtained by dissolving or dispersing the electroconductive polymer according to claim 15.

21. The electroconductive polymer aqueous solution according to claim 20, comprising a resin and/or a substance which is changed to a resin by a reaction by heat or light, as a binder.

22. An electroconductive polymer film, obtained by drying the electroconductive polymer aqueous solution according to claim 20 to remove a solvent.

23. A solid electrolytic capacitor, comprising an anode conductor comprising a valve metal and a dielectric layer formed on a surface of the anode conductor, wherein a solid electrolyte layer comprising the electroconductive polymer film according to claim 22 is formed on a surface of the dielectric layer.

24. The solid electrolytic capacitor according to claim 23, wherein the valve metal is at least one selected from the group consisting of aluminum, tantalum, and niobium.

25. A method for producing a solid electrolytic capacitor, comprising:
forming an dielectric layer on a surface of an anode conductor comprising a valve metal and
forming a solid electrolyte layer by impregnating a surface of the dielectric layer with the electroconductive polymer aqueous solution according to claim 20.

26. A method for producing a solid electrolytic capacitor, comprising:
forming a dielectric layer on a surface of an anode conductor comprising a valve metal;
forming a first electroconductive polymer compound layer on a surface of the dielectric layer by a chemical oxidation polymerization or an electropolymerization of a monomer providing a first electroconductive polymer compound; and
forming a second electroconductive polymer compound layer by impregnating a surface of the first electroconductive polymer compound layer with the electroconductive polymer aqueous solution according to claim 20.

27. The method for producing a solid electrolytic capacitor according to claim 26, wherein the first electroconductive polymer compound is a polymer of at least one selected from the group consisting of pyrrole, thiophene, aniline, and a derivative thereof.

28. The method for producing a solid electrolytic capacitor according to claim 25, wherein the valve metal is at least one selected from the group consisting of aluminum, tantalum, and niobium.
